(19) United States
(12) Patent Application Publication
(10) Pub. No.: US 2022/0260215 A1
(43) Pub. Date: Aug. 18, 2022

(54) PROPANE CYLINDER STABILIZING BASE

(71) Applicants: Robert Vincent Schmick, Great Valley, NY (US); James William Gilfert, Eldred, PA (US)

(72) Inventors: Robert Vincent Schmick, Great Valley, NY (US); James William Gilfert, Eldred, PA (US)

(21) Appl. No.: 17/372,415

(22) Filed: Jul. 10, 2021

Related U.S. Application Data
(60) Provisional application No. 63/149,100, filed on Feb. 12, 2021.

(51) Int. Cl. F17C 13/08; D21J 7/00

(52) U.S. Cl. CPC F17C 13/084; D21J 7/00; F17C 2201/058; F17C 2205/0153; F17C 2201/0109; F17C 2221/035

(57) ABSTRACT

The present disclosure is directed to a base configured to support a propane tank. The base can include a curved interior sidewall defining a cavity configured to receive the propane tank therein, the curved interior sidewall configured to frictionally engage the propane tank when the propane tank is inserted within the base and a roughened exterior surface positioned on an underside of the cavity, the roughened surface configured to frictionally engage with a surface on which the base is positioned. Further, the base can be constructed from a biodegradable molded pulp material.

### PRIORITY

The present application claims priority to U.S. Provisional Patent Application No. 63/149,100, titled PROPANE CYLINDER STABILIZING BASE, filed Feb. 12, 2021, which is hereby incorporated by reference herein in its entirety.

### BACKGROUND

Due to the volatile compounds that they contain, there is a significant need to ensure that propane cylinders (“tanks”) (e.g., 20 lb. propane cylinders), commonly used for grilling and patio heaters remain stabilized and upright during transport. One can accomplish this by providing the tanks with wide bases. However, the tanks themselves cannot reasonably be constructed to have extremely wide bases because of the cost of the additional materials, the increased display and transportation space that the tanks would occupy, and the problems the increased size would create for consumers. Therefore, there is a need in the technical field for bases for propane tanks and other similar objects that adequately support or stabilize the propane tank during transport, while balancing cost. Further, it would be desirable for such stabilizing bases to be constructed from biodegradable and/or recyclable materials in order to minimize the environmental impacts of the devices.

### SUMMARY

In various embodiments, the present disclosure is directed to a base configured to support a propane tank. The base can comprise a curved interior sidewall defining a cavity configured to receive the propane tank therein, the curved interior sidewall configured to frictionally engage the propane tank when the propane tank is inserted within the base, and a roughened exterior surface positioned on an underside of the cavity, the roughened surface configured to frictionally engage with a surface on which the base is positioned, wherein the base is constructed from a biodegradable molded pulp material.

In various embodiments, the present disclosure is directed to a method of fabricating a base configured to support a propane tank, the method comprising: mixing a biodegradable pulp material with a carrier; depositing, via the carrier, the biodegradable pulp material on a surface of a mold, the mold configured to form the biodegradable pulp material into the base such that the base comprises: a curved interior sidewall defining a cavity configured to receive the propane tank therein, the curved interior sidewall configured to frictionally engage the propane tank when the propane tank is inserted within the base, and a roughened exterior surface positioned on an underside of the cavity, the roughened surface configured to frictionally engage with a surface on which the base is positioned; and drying the biodegradable pulp material molded into the base.

### FIGURES

The accompanying drawings, which are incorporated in and form a part of the specification, illustrate the embodiments of the invention and together with the written description serve to explain the principles, characteristics, and features of the invention. In the drawings:

FIG. 1 depicts a perspective view of a base for a propane tank, in accordance with an embodiment of the present disclosure.

FIG. 2 depicts an overheard view of the base of FIG. 1, in accordance with an embodiment of the present disclosure.

FIG. 3 depicts a side view of the base of FIG. 1, in accordance with an embodiment of the present disclosure.

FIG. 4 depicts a view of the base of FIG. 1 with a propane tank therein, in accordance with an embodiment of the present disclosure.

### DESCRIPTION

This disclosure is not limited to the particular systems, devices and methods described, as these may vary. The terminology used in the description is for the purpose of describing the particular versions or embodiments only, and is not intended to limit the scope.

The present disclosure is generally directed to a base, which can also be referred to as a base support or a holder, for a propane tank or cylinder. The base is generally designed to widen the bottom of the propane tank to provide increased stability during transport.

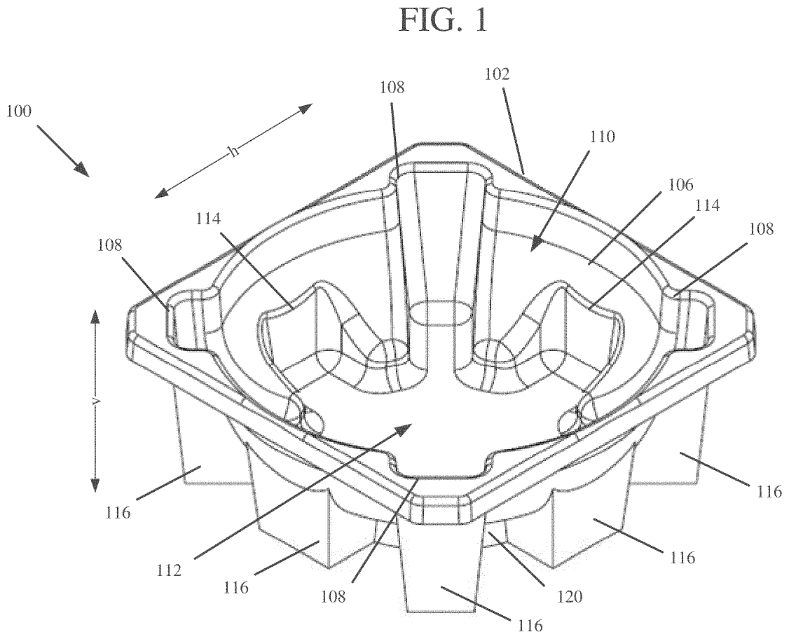

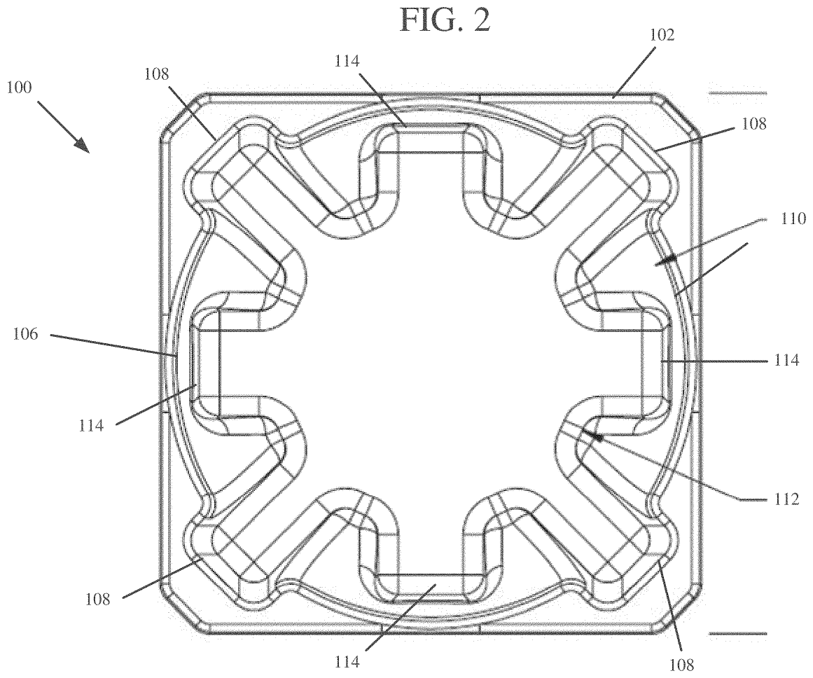

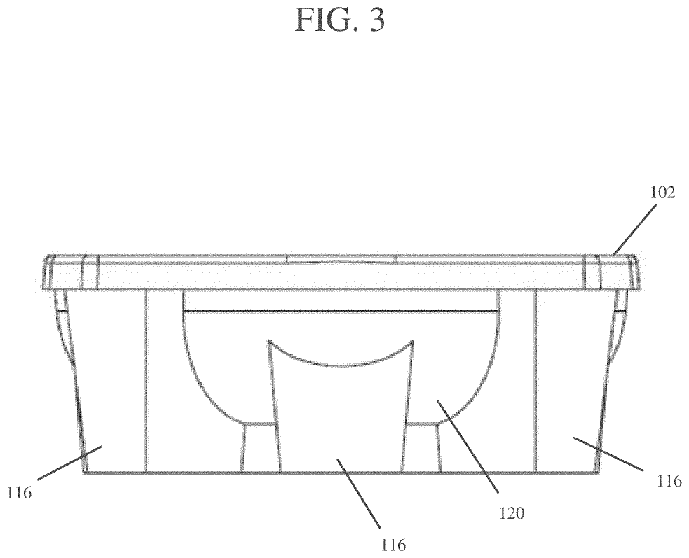

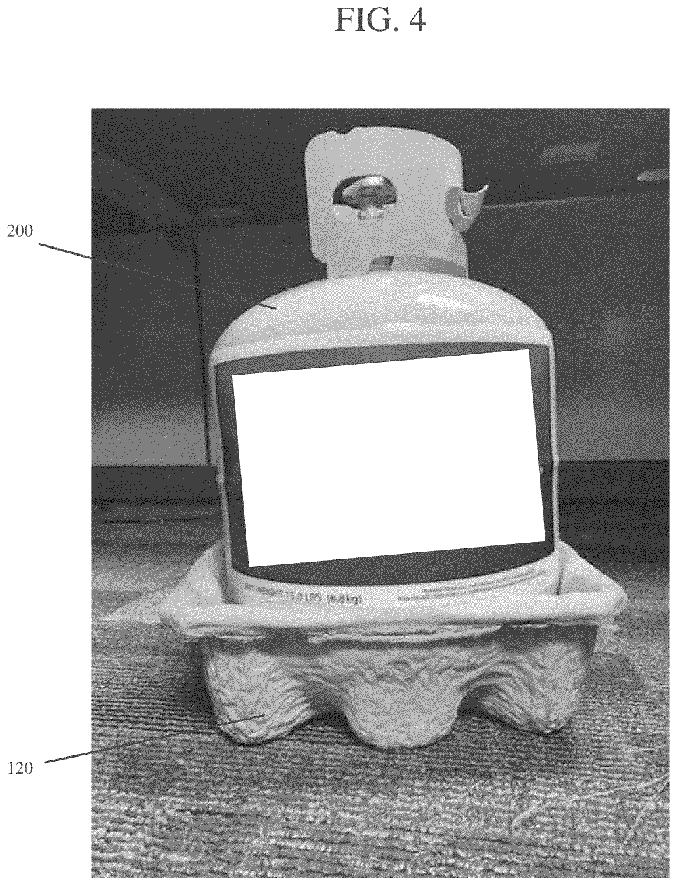

Referring now to FIGS. 1-4, there are shown various views of a base 100 for holding a propane tank 200. The base 100 includes a peripheral edge 102 enclosing an interior sidewall 106 defining a cavity 110 that is sized, shaped, or otherwise configured to receive a propane tank 200 therein. In one embodiment, the base 100 can be constructed from a molded biodegradable material, such as recycled cellulose or other fibrous or pulp materials. In particular, the cavity 110 can be generally semi-spherical, circular, or cylindrical in shape. In one embodiment, the peripheral edge 102 can generally define a rectangular or square shape; however, other shapes can be used in other embodiments. The interior sidewall 106 is sized, shaped, or otherwise configured to frictionally engage with the sides of a propane tank 200 to hold the propane tank 200 in place therewithin (e.g., as shown in FIG. 4). In one embodiment, the width or diameter of the cavity 110 defined by the interior sidewall 106 can be substantially equal to a close tolerance of a width of a propane tank 200. In various embodiments, the width or diameter of the cavity 110 defined by the interior sidewall 106 can be altered to control the amount of frictional engagement between the interior sidewall 106 and the propane tank 200. For example, the distance between the opposing sides of the interior sidewall 106 could be set to allow the propane tank 200 to be easily slid into the base 100 or could be set to require that the propane tank 200 be actively pushed into the base 100 to be secured therewithin. Further, the interior sidewall 106 can have a curved shape that substantially matches or corresponds to the curvature of a propane tank 200 in one or multiple directions. In one embodiment, the interior sidewall 106 can have a first curvature in a horizontal direction (indicated by the arrow “h”) and a second curvature in a vertical direction (indicated by the arrow “v”) that correspond to the horizontal and vertical curvatures of a propane tank 200 so that the interior cavity 110 generally conforms to the propane tank 200.

In one embodiment, the base 100 can include first cutouts 108 positioned along the interior sidewall 106. In the illustrated embodiment, the first cutouts 108 are positioned to correspond to the corners of the peripheral edge 102, but in other embodiments the upper cutouts 108 can be positioned at other locations. In one embodiment, the base 100 can further include second cutouts 114 positioned along the interior sidewall 106 intermediately relative to the first cutouts 108. Further, the first and second cutouts 108, 114 can have different dimensions with respect to each other. For example, in the illustrated embodiment, the first cutouts 108 generally extend the entire depth of the interior sidewall 106, whereas the second cutouts 114 begin at an intermediate position along the interior sidewall 106 and thus only extend a portion of the depth of the interior sidewall 106. The first and second cutouts 108, 114 can be beneficial in embodiments where the base 100 is constructed from a molded pulp material because molded pulp materials provide increased strength at turns due to the increased accumulation of the material at the turns. Accordingly, the first and second cutouts 108, 114 provide vertical reinforcement to the base 100. The first and second cutouts 108, 114 can also be beneficial in order to facilitate the removal of the propane tank 200 from the base 100 by controlling the amount of the interior sidewall 106 that frictionally engages the propane tank 200.

In one embodiment, the interior sidewall 106 can further define a lower cavity 112 that is sized, shaped, or otherwise configured to receive the bottom or stand portion of a propane tank 200. In this embodiment, the cavity 110 (or “upper” cavity) can be configured to correspond to the main, cylindrical portion of the propane tank 200.

In one embodiment, the base 100 can further include one or more legs 116 positioned exteriorly relative to the cavity 110. The legs 116 can include or be components of an exterior surface 120 of the base 100. The legs 116 can extend vertically from the cutouts 108, 114 and terminate in a flat or planar side, thereby allowing the base 100 to sit in a secure manner on a flat surface. In one embodiment, the legs 116 can define a generally rectangular or square shape; however, other shapes can be used in other embodiments. The legs 116 are positioned such that the distance between opposing sets of the legs 116 is greater than a width or diameter of the propane tank 200, thereby providing a wider base of support for the propane tank 200 to stabilize the propane tank 200 during transport.

Generally in the construction of objects from molded pulp materials, the resulting objects will have a relatively smooth surface on one side and a relatively roughened surface on the opposing side. Therefore, in embodiments where the base 100 is constructed from a molded pulp material, it can be beneficial for the base 100 to be constructed in a manner that causes the roughened surface to be the exterior surface 120 of the base 100 (e.g., as shown in FIG. 4) because the roughened exterior surface 120 can provide for improved frictional engagement between the base 100 and a surface on which the base 100 is located.

As noted above, the fiber material from which the base 100 is constructed can include a biodegradable material, such as recycled cellulose or other fibrous or pulp materials. During fabrication, the fiber material can be mixed with water or other carrier and deposited on the surface of a mold that is shaped or otherwise configured to form the base 100. For example, the fiber material can be mixed with water and then pumped through a screen-like mold in the shape of the base 100. The mixture of the fiber material and the water can then be selectively pumped through the reverse side of the mold, causing the mold to trap or attract the fiber material. Accordingly, as the mixture is pumped through the mold, the mold forms the fiber material into the shape of the base 100. The molded fiber material is then dried, thereby forming the base 100.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A base configured to support a propane tank, the base comprising:
a curved interior sidewall defining a cavity configured to receive the propane tank therein, the curved interior sidewall configured to frictionally engage the propane tank when the propane tank is inserted within the base; and
a roughened exterior surface positioned on an underside of the cavity, the roughened exterior surface configured to frictionally engage with a surface on which the base is positioned;
wherein the base is constructed from a biodegradable molded pulp material.

2. The base of claim 1, further comprising one or more cutouts located along the curved interior sidewall, the one or more cutouts configured to structurally reinforce the base.

3. The base of claim 2, wherein the one or more cutouts are located at one or more corners of the base.

4. The base of claim 2, wherein:
the one or more cutouts comprise one or more first cutouts and one or more second cutouts;
the one or more first cutouts extend a depth of the curved interior sidewall;
the one or more second cutouts extend less than the depth of the curved interior sidewall; and
the one or more second cutouts are positioned intermediately with respect to the one or more first cutouts.

5. The base of claim 1, wherein the base is rectangular in shape.

6. The base of claim 1, further comprising one or more legs extending from the roughened exterior surface, the one or more legs defining a rectangular shape.

7. The base of claim 1, wherein the biodegradable molded pulp material comprises recycled cellulose.

8. The base of claim 1, wherein the curved interior sidewall comprises a width that is equal to a close tolerance of a width of the propane tank.

9. The base of claim 1, wherein the curved interior sidewall comprises a curvature that is equal to a close tolerance of a curvature of the propane tank.

10. The base of claim 9, wherein:
the curvature of the curved interior sidewall comprises a first curvature;
the first curvature is in a first direction and corresponds to a first curvature of the propane tank; and
the curved interior sidewall comprises a second curvature that is in a second direction and corresponds to a second curvature of the propane tank.

11. The base of claim 1, further comprising:
a lower cavity positioned below the cavity, the lower cavity configured to receive a stand portion of the propane tank.

12. A method of fabricating a base configured to support a propane tank, the method comprising:
mixing a biodegradable pulp material with a carrier;
depositing, via the carrier, the biodegradable pulp material on a surface of a mold, the mold configured to form the biodegradable pulp material into the base such that the base comprises:
a curved interior sidewall defining a cavity configured to receive the propane tank therein, the curved interior sidewall configured to frictionally engage the propane tank when the propane tank is inserted within the base, and
a roughened exterior surface positioned on an underside of the cavity, the roughened exterior surface configured to frictionally engage with a supporting surface on which the base is positioned; and
drying the biodegradable pulp material molded into the base.

13. The method of claim 12, wherein the carrier comprises water.

14. The method of claim 12, wherein depositing the biodegradable pulp material on the surface of the mold comprises:
pumping the biodegradable pulp material mixed with the carrier through a first side of the mold; and
selectively pumping the biodegradable pulp material mixed with the carrier through a second side of the mold to cause the mold to trap the biodegradable pulp material, thereby causing the roughened exterior surface to be positioned on the underside of the cavity.

15. The method of claim 12, wherein the mold is further configured to form the biodegradable pulp material into the base such that the base comprises:
one or more cutouts located along the curved interior sidewall, the one or more cutouts configured to structurally reinforce the base.

16. The method of claim 15, wherein the one or more cutouts are located at one or more corners of the base.

17. The method of claim 15, wherein:
the one or more cutouts comprise one or more first cutouts and one or more second cutouts;
the one or more first cutouts extend a depth of the curved interior sidewall;
the one or more second cutouts extend less than the depth of the curved interior sidewall; and
the one or more second cutouts are positioned intermediately with respect to the one or more first cutouts.

18. The method of claim 12, wherein the biodegradable pulp material comprises recycled cellulose.

19. The method of claim 12, wherein the mold is further configured to form the biodegradable pulp material into the base such that the curved interior sidewall comprises a width that is equal to a close tolerance of a width of the propane tank.

20. The method of claim 12, wherein the mold is further configured to form the biodegradable pulp material into the base such that the curved interior sidewall comprises a curvature that is equal to a close tolerance of a curvature of the propane tank.

21. The base of claim 20, wherein:
the curvature of the curved interior sidewall comprises a first curvature;
the first curvature is in a first direction and corresponds to a first curvature of the propane tank; and
the mold is further configured to form the biodegradable pulp material into the base such that the curved interior sidewall comprises a second curvature that is in a second direction and corresponds to a second curvature of the propane tank.
